(19) United States
(12) Patent Application Publication
(10) Pub. No.: US 2013/0119175 A1
(43) Pub. Date: May 16, 2013

(54) ELEMENT OF A DRUM-SHAPED COMMINUTING TRACK

(71) Applicant: Andritz Fiedler GmbH, Regensburg (DE)

(72) Inventors: Georg BORSTE, Rosenheim (DE); Tobias MICHEL, Werbachhausen (DE)

(73) Assignee: Andritz Fiedler GmbH, Regensburg (DE)

(21) Appl. No.: 13/672,507

(22) Filed: Nov. 8, 2012

(30) Foreign Application Priority Data
Nov. 10, 2011 (DE) 10 2011 118 228.8

(51) Int. Cl. B02C 13/282

(52) U.S. Cl. CPC B02C 13/282
USPC 241/291

(57) ABSTRACT

An element for a drum-shaped comminuting track in a comminuting machine through which gas flows and which has a rotating beater wheel system, the element including: a profile section including alternating ribs and grooves, and a distance section arranged successively in a material flow direction (F) or axial direction, and the ribs include curved profile edges arranged at a material inlet side at an angle (α) or at a material outlet side at a different angle (β) with respect to a line perpendicular to a symmetry axis of the element.

### BACKGROUND OF THE INVENTION

The invention relates to an element of a drum-shaped comminuting track which is provided in particular for a comminuting machine through which gas flows and which has a rotating beater wheel system.

FIG. 7 shows a conventional drum-shaped comminuting track 100 on a rotating beater wheel system 102 for a comminuting machine 104 through which gas 106, as is know from EP 0 164 489. The track is formed of elements 112. A conventional element 112 of the drum-shaped comminuting track is known from EP 1 010 465 B1. Each element of the drum-shaped comminuting track comprises a profile section having ribs and grooves, and a distance section. The profile and distance sections are arranged successively in a material flow direction which is typically around the circumference of the track. A circular array of these elements forms a cylindrical surface of a grinding track on which feedstock is comminuted by grinding. The grinding is effected by the beater wheel having circumferential surface facing the track and moving relative to the track. The degree of grinding is influenced and controlled by the residence time of the feedstock in the comminuting grinding track and by the configuration of ribs and grooves in the profiles sections. There is a need for improvements for the adjustability of the degree of grinding and the energy consumption in such comminuting machines through which gas flows.

### BRIEF SUMMARY OF THE INVENTION

An element of a drum-shaped comminuting track has been conceived which permits adjustability of the degree of grinding while achieving improved energy consumption. The drum-shaped comminuting track may be in a comminuting machine through which gas flows. The machine includes a rotating beater wheel system.

Each element of the comminuting track comprises a profile section including alternating ribs and grooves and a distance section. The profile and distance sections are arranged successively in a material flow direction, e.g., a circumferential direction around the annular track. The ribs of the profile section have curved profile edges at an angle (α) at a material inlet side or at a different angle (β) at a material outlet side. These angles are with respect to a line perpendicular to a symmetry axis of the element.

Due to the curved path of the profile edge of the ribs of the profile section, an elongation of the cutting edge length is achieved as compared to a straight path as in the prior art. As a result, it is possible to lengthen the residence time by setting the profile edges at the material inlet side and material outlet side in the manner described herein. The resistance as the grinding stock passes through can be reduced in such a way that more favorable energy consumption values are achieved. This setting also makes it possible to reduce the wear on the profile sections during operation of the comminuting machine through which gas flows, as a result of which the service lives of the relevant elements of the drum-shaped comminuting track can be extended and the chosen replacement intervals for the elements can be longer.

The angle (α) at the material inlet side may lie in a range from 65° to 90°. The angle (β) at the material outlet side may lie in a range from 35° to 70°. Optimum and favorable energy consumption values can be achieved within these angle ranges.

The ribs and grooves of the profile sections of two successive elements in the axial direction are flush with one another. By this means, seen over the periphery of the comminuting track, one obtains an uninterrupted, even through-flow with feedstock for the purpose of even and repeatable comminution of said feedstock in the machine according to the invention.

An element of a drum-shaped comminuting track has been conceived for a comminuting machine through which gas flows and which has a rotating beater wheel system. The element comprises a profile section, which has alternating ribs and grooves, and a distance section. The elements are arranged successively in the material flow direction, e.g., circumferentially over the track. The ribs of the profile sections delimit grooves expanding or narrowing in the material flow direction. Expanding or narrowing the grooves modifies the flow ratios within the groove and controls the residence time of the material to be ground. In the case of narrowing grooves, the flow speed in the groove is decelerated and at the same time a portion of the material to be ground is directed over the profile edges and thus the degree of grinding is increased. In particular, the wear in relation to the degree of grinding can be reduced by narrowing the grooves. At the same time, the energy consumption, e.g. the electricity consumption, can also be decreased due to the reduced wear.

In the case of an expansion of the grooves in the circumferential material flow direction, the output of the material to be ground is improved and clogging of the grooves is prevented. In particular, smaller material can be conveyed out of the grinding chamber more easily and faster while coarse grinding stock can remain in the grinding chamber longer.

The setting angle of the grooves with respect to a line perpendicular to the circumferential material flow direction may vary along the length of the track in the peripheral direction from the symmetrical axis. The setting angle can become larger or smaller in the peripheral direction. The setting angle and the change in the setting angle facilitate a favorable adjustment of the size of the feedstock and the size of the desired comminuted material. As a result, the degree of grinding of such a machine is influenced in a specific manner. For instance, the residence time of the material to be ground in the grinding chamber is increased with a large setting angle and finer ground material is produced. With a smaller setting angle, on the other hand, the grinding stock is removed from the grinding chamber more quickly and the degree of grinding is reduced overall.

An element has been conceived for a drum-shaped comminuting track, such as is intended in particular for a comminuting machine through which gas flows and which has a rotating beater wheel system, wherein each element comprises a profile section, which has alternating ribs and grooves, and a distance section that are arranged successively in the material flow direction or the axial direction, respectively, such an element is characterized in that the ribs of the profile sections delimit grooves which are preferably conically shaped and arranged asymmetrically.

It is substantial to the design of the element of a drum-shaped comminuting track that the profile edges of the profile section which delimit the grooves have a curved path. As a result of the curved path, the profile edge length increases such that the feedstock can remain on the grinding track longer. As a result, the degree of grinding can be adjusted to achieve favorable energy consumption values by an appropriate selection of the setting angle of the material inlet side and of the material outlet side, and at the same time wear can also be reduced.

### BRIEF DESCRIPTION OF THE DRAWINGS

The invention will be explained in greater detail below on the basis of preferred embodiments with reference to the attached drawing. The drawing shows:

FIG. 1 is a perspective view of an individual element of a drum-shaped comminuting track.

FIGS. 2a to 2c are schematic plan views of layout examples of a plurality of elements of a drum-shaped comminuting track which are successive in an annular array.

FIG. 3 a plan view onto an embodiment variation and a variation of a layout example for a plurality of individual elements of a drum-shaped comminuting track.

FIG. 4 is a schematic plan view onto an embodiment variation and a variation of a layout example for one or a plurality of individual elements of a drum-shaped comminuting track.

FIG. 5 is a schematic plan view onto an embodiment variation and a variation of a layout example for one or a plurality of individual elements of a drum-shaped comminuting track.

FIG. 6 is a schematic plan view onto an embodiment variation and a variation of a layout example of one or a plurality of individual elements of a drum-shaped comminuting track.

FIG. 7 is an axial view of a cross-sectional view of a conventional drum-shaped track on a conventional comminuting machine.

### DETAILED DESCRIPTION OF THE INVENTION

The embodiment examples illustrated are preferred embodiments without being restrictive in character. In the Figures of the drawing, the same or similar elements are provided with the same reference numbers.

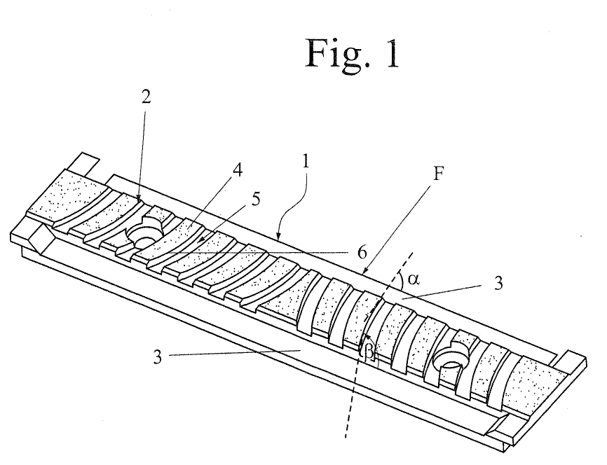

The individual element shown in FIG. 1 in a perspective view, which is provided in its entirety with the reference number 1, is intended for a drum-shaped comminuting track not illustrated in greater detail of a comminuting machine which is also not illustrated in greater detail through which gas flows and which has a rotating beater wheel system.

The individual element 1 comprises a profile section 2 and, seen in the circumferential direction, a distance section 3 on both sides. Profile section 2 comprises alternating ribs 4 and grooves 5. Profile section 2 of individual element 1 and distance section 3 are indicated by an arrow F in the material flow direction or are arranged successively an annular array.

As can be seen from FIG. 1, ribs 4 of the profile section 2 have curved profile edges 6 which delimit grooves 5. Each profile edge 6 is at an angle α at the material inlet side. Alternatively or additionally, each profile edge 6 of individual element 1 can be arranged at the material outlet side at a different angle β to this with respect to a line perpendicular to the symmetry axis, e.g., an axis bisecting the left and right sides of the element and parallel to the material flow. A range of 65° to 90° is provided as the preferred angle range for angle α at the material inlet side. The angle range for angle β at the material outlet side can be specified as 35° to 70°.

Several individual elements 1 form, in a circular array, the surface of a drum-shaped comminuting track which is not shown in greater detail. These form longer cutting edge lengths due to the curved path of profile edges 6. As a result, the feedstock to be comminuted can remain longer between individual element 1 and the rotating beater wheel system such that the degree of comminution or the degree of grinding can be adjusted in a favorable manner.

Due to the setting angle at the material inlet side or the material outlet side, the resistance and the wear of the profile edges and profile sections can be decreased, as a result of which the energy requirement necessary for operation of the comminuting machine can be reduced. In this manner, one therefore obtains a configuration more favorable in terms of energy of individual element 1 of a drum-shaped comminuting track.

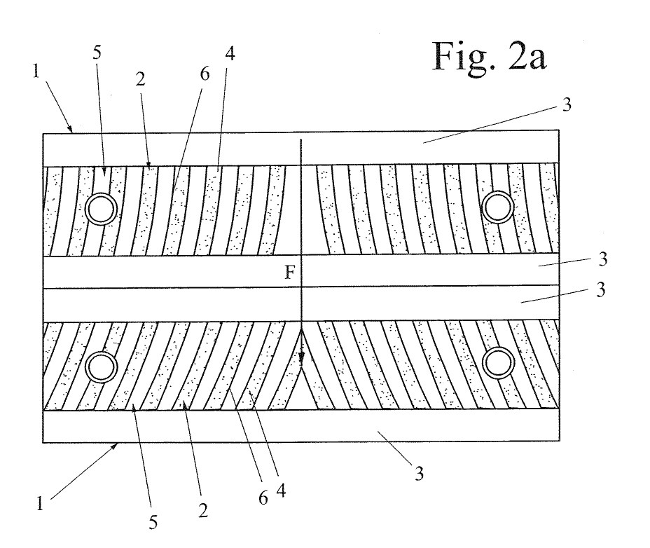

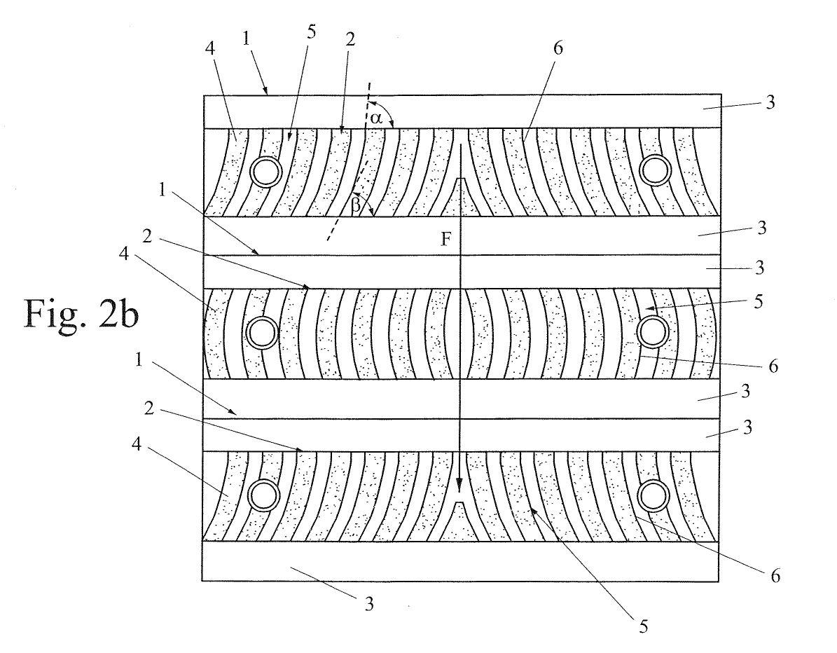

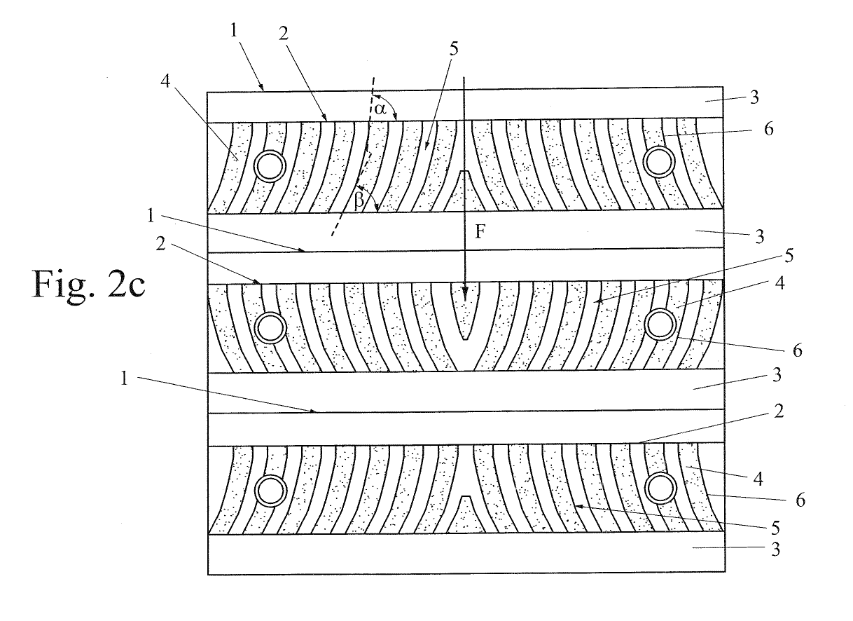

FIG. 2a shows a layout example of two individual elements 1 which are successive in the peripheral direction extending outward from the symmetrical axis. As can be seen from FIG. 2a, in this case the arrangement is such that each of ribs 4 and grooves 5 of profile section 2 are aligned flush with each other. In the layout variation according to FIG. 2b, which shows an example of three elements 1 that are successive in the peripheral direction or in the circumferential direction, respectively, the design is such that the two outer individual elements 1 are aligned in the same direction while the individual element 1 lying therebetween has a different alignment of the ribs 4 and grooves 5. In the embodiment example according to FIG. 2c, the three individual elements 1 provided there are provided in an offset arrangement successively in the peripheral direction. In FIGS. 2a to 2c, angle α is indicated schematically at the material inlet side and angle β at the material outlet side.

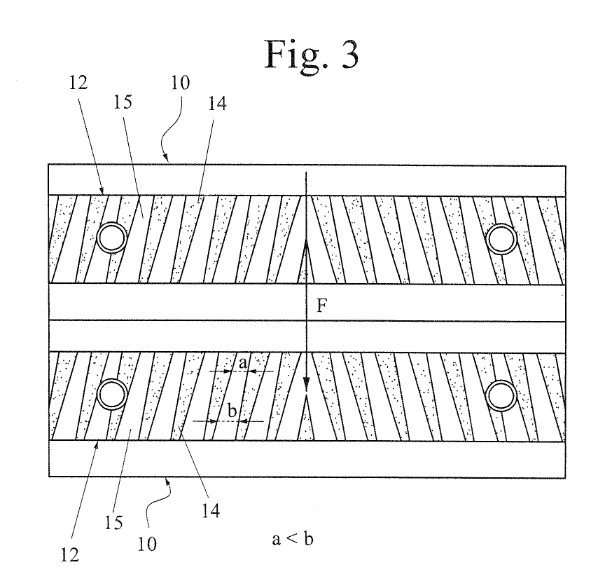

FIG. 3 shows a schematic plan view an embodiment variation for the individual element which is designated there in its entirety by the numeral 10. A layout variation is also shown with two such individual elements 10 which are arranged successively in the peripheral direction.

Profile section 12 comprises ribs 14 and grooves 15 arranged alternately. In the embodiment variation of individual element 10 illustrated in FIG. 3, ribs 14 are configured in such a way that grooves 15 are formed between them, said grooves expanding in material flow direction F as is illustrated by “a” and “b”. In the two individual elements 10 illustrated in the layout variation, the design is such that individual elements 10 are aligned in the same direction with respect to each other.

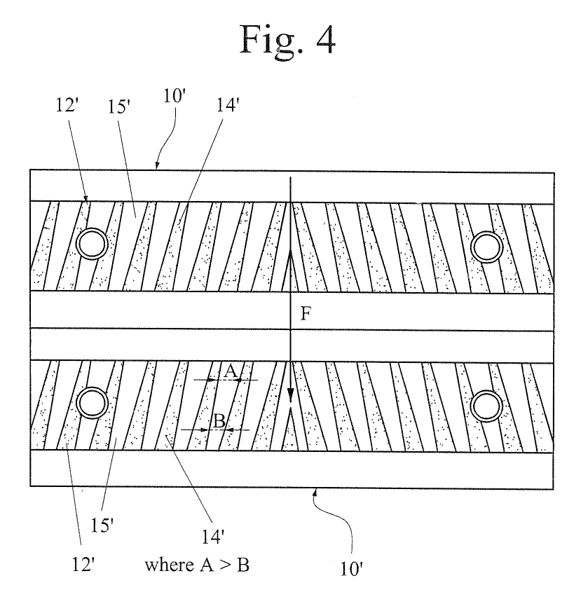

In the embodiment variation according to FIG. 4, the two individual elements 10′ shown there each have a profile section 12′ comprising ribs 14′ and grooves 15′ wherein grooves 15′ formed between ribs 14′ narrow in material flow direction F as is illustrated by “A” and “B” in the Figure.

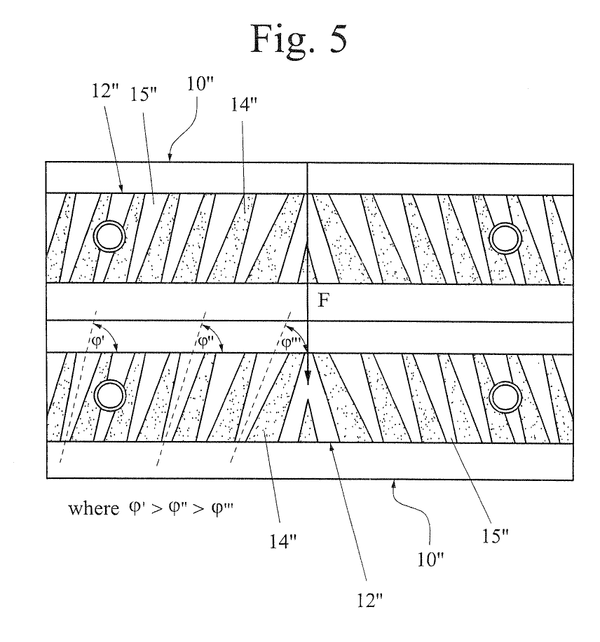

FIG. 5 illustrates individual elements 10″, grooves 15″ of which also expand in material flow direction F as in FIG. 3. In addition, setting angles δ formed by the grooves 15″ with respect to a line perpendicular to the material flow direction F change in the peripheral direction, that is in the sense of becoming smaller from the side edges of the element 10″ to the symmetry axis. (δ′<δ″<δ′″).

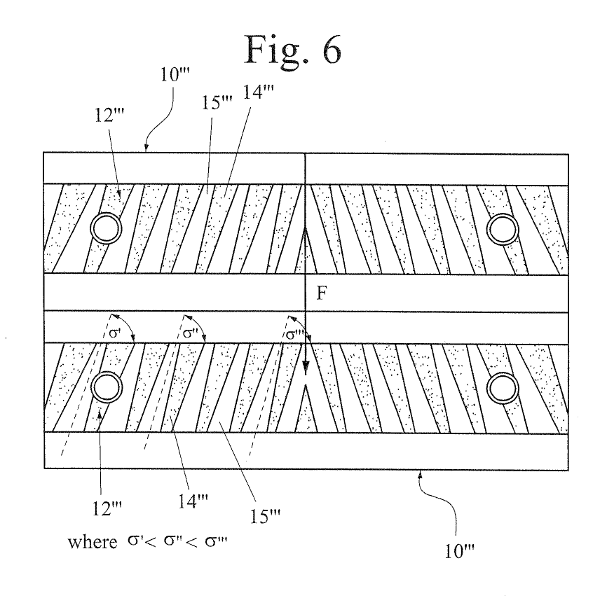

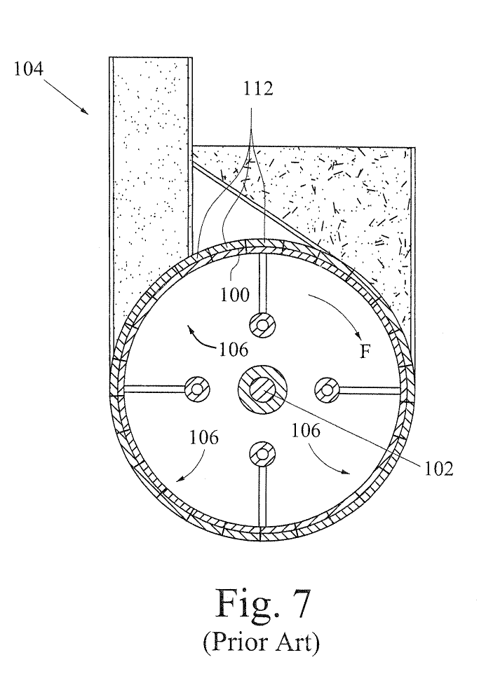

FIG. 6 shows two individual elements 10′″ which, similar to FIG. 4, narrow in material flow direction F but where the setting angles δ, become larger from the side edges to the line of symmetry of the element 10″. (δ′<δ″<δ′″). With all these additional embodiment variations of individual elements 1, 10, 10′, 10″ and 10′″, it is possible in each case to achieve Adjustments to a desired degree of grinding in a better manner.

The material flow direction in all Figures of the drawing is indicated in each case by an arrow which bears the reference character F.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

We claim:

1. An element for a drum-shaped comminuting track in a comminuting machine through which gas flows and which has a rotating beater wheel system, the element comprising:
a profile section including alternating ribs and grooves, and a distance section arranged successively in a material flow direction (F) or axial direction, and
the ribs include curved profile edges arranged at a material inlet side at an angle (α) or at a material outlet side at a different angle (β) with respect to a line perpendicular to a symmetry axis of the element.

2. The element according to claim 1 wherein the angle (α) at the material inlet side lies in a range from 65° to 90° or the angle (β) at the material outlet side lies in a range from 35° to 70°.

3. The element according to claim 1 wherein the ribs and the grooves of the profile sections of two respective elements are successive in the axial direction are flush.

4. An element for a drum-shaped comminuting track in a comminuting machine through which gas flows and which has a rotating beater wheel system, the element comprising:
a plurality of profile sections each including alternating ribs and grooves, and
at least one distance section interleaved with profile sections along a material flow direction (F),
wherein the ribs on the profile sections delimit the grooves which expand or narrow in the material flow direction (F).

5. The element according to claim 4 wherein the grooves continuously expand or continuously narrow in the material flow direction (F).

6. The element according to claim 4 wherein a setting angle (δ) of the grooves with respect to the material flow direction (F) changes in a peripheral direction.

7. The element according to claim 6 wherein the setting angle (δ) increases in the peripheral direction.

8. The element according to claim 6 wherein the setting angle (δ) shrinks in the peripheral direction.

9. An element configured to be assembled into a cylindrical array of elements in a drum-shaped comminuting track, each element comprising:
a profile section including alternating ribs and grooves, and
a distance section,
wherein the elements are to be arranged successively in the cylindrical array in a material flow direction, and wherein the ribs of the profile sections delimit grooves that converge or diverge and are arranged asymmetrically about a symmetrical axis bisecting the element and parallel to a material flow direction over the element.

10. The element according to claim 9 wherein the ribs each include a sidewall adjacent one the grooves, and the sidewalls at an material inlet edge of the profile section each form an angle (α) in a range of 65 degrees to 90 degrees with respect to a line perpendicular to a symmetry axis of the element.

11. The element according to claim 9 wherein the ribs each include a sidewall adjacent one the grooves, and the sidewalls at an material outlet edge of the profile section each form an angle (β) in a range from thirty-five degrees to seventy degrees with respect to a line perpendicular to a symmetry axis of the element.

12. The element according to claim 9 wherein the ribs and the grooves of the profile sections of two successive ones of the elements are flush.

13. An element for a drum-shaped comminuting track in a comminuting machine comprising:
a plurality of profile sections each including alternating ribs and grooves, and
a plurality of distance sections interleaved between the profile sections along a material flow direction (F) over the track,
wherein grooves between the ribs expand or narrow in the material flow direction (F).

14. The element according to claim 13 wherein the grooves continuously expand or continuously narrow in the material flow direction (F).

15. The element according to claim 13 wherein a setting angle (δ) of the grooves with respect to the material flow direction (F) changes in a direction from a center of the element to a periphery of the element.

16. The element according to claim 15 wherein the setting angle (δ) for grooves near the center of the element is smaller than for grooves hear the periphery of the element.

17. The element according to claim 15 wherein the setting angle (δ) for grooves near the center of the element is larger than for grooves near the periphery of the element.
